(19) United States
(12) Patent Application Publication
(10) Pub. No.: US 2025/0053062 A1
(43) Pub. Date: Feb. 13, 2025

(54) METHODS AND APPARATUSES FOR ACOUSTO-OPTIC DEVICE BEAM DISPLACEMENT AND ANGLE COMPENSATION

(71) Applicant: IonQ, Inc., College Park, MD (US)

(72) Inventors: Joachim WELTE, Carrboro, NC (US); Kai Makoto HUDEK, Hyattsville, MD (US); Jessica Marie PEHR, Albuquerque, NM (US)

(21) Appl. No.: 18/797,290

(22) Filed: Aug. 7, 2024

Related U.S. Application Data
(60) Provisional application No. 63/518,748, filed on Aug. 10, 2023.

(51) Int. Cl. G02F 1/33

(52) U.S. Cl. CPC G02F 1/33

(57) ABSTRACT

Aspects of the present disclosure may include a method and/or a system for providing an acousto-optic deflector (AOD), emitting, toward a first deflector plate, a source beam, deflect the source beam, via the first deflector plate, to generate a deflected source beam toward the AOD, diffract, via the AOD, the deflected source beam to generate at least one diffracted beam, toward a second deflector plate, and deflect the at least one diffracted beam, via the second deflector plate, to generate a deflected diffraction light, wherein the source beam and the deflected diffraction light are collinear or substantially collinear.

### CROSS-REFERENCE TO RELATED APPLICATIONS

The present application claims priority to, and the benefit of, U.S. Provisional Application No. 63/518,748 filed on Aug. 10, 2023 and entitled “METHODS AND APPARATUSES FOR ACOUSTO-OPTIC DEVICE BEAM DISPLACEMENT AND ANGLE COMPENSATION, the contents of the which are hereby incorporated by reference therein in their entireties.

### TECHNICAL FIELD

Aspects of the present disclosure relate generally to systems and methods for use in the implementation and/or operation of quantum information processing (QIP) systems, and more particularly, to operations of multiple QIP systems.

### BACKGROUND

In a quantum information processing (QIP) system, the QIP system may use a variety of acousto-optic (AO) devices. Acousto-optic modulators (AOM) may be used for gate control via amplitude, phase, and frequency modulation of laser beams. Acousto-optic deflectors (AOD) can be used for beam steering, as well as amplitude and phase modulation.

These AO devices are based on the diffraction of beams of light by a grating formed by an acoustic wave in the device crystal. Diffraction leads to the incoming beams and the diffraction orders having one or more angles between them. The angle θ is given by the Bragg condition sin(0)=λ*/d, where λ is the wavelength of the light, d the wavelength of the acoustic wave, and m is the diffraction order. In many applications, one of the 1st order diffracted beams may be utilized through the rest of the optical system.

The angle (resulting in beam displacement along the beam path) between the incoming beam and the 1st order diffracted beam may pose a challenge in the design of more compact opto-mechanical systems. This may require compensation, either in the upstream or downstream optomechanical design.

This angle and/or a lateral displacement between the incoming beam and the diffracted beam can be mitigated by modifying the input and output facets of the AO crystal and by making use of the refraction at the air-crystal interface. This modification then allows to optimize for diffracted beam angle at any time. Further optimization might be desirable in order to make the design more adaptable and resilient to manufacturing tolerances on the modified crystal facet angle.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

Aspects of the present disclosure may include methods and systems for providing an acousto-optic deflector (AOD), emitting, toward a first deflector plate, a source beam, deflect the source beam, via the first deflector plate, to generate a deflected source beam toward the AOD, diffract, via the AOD, the deflected source beam to generate at least one diffracted beam, toward a second deflector plate, and deflect the at least one diffracted beam, via the second deflector plate, to generate a deflected diffraction beam, wherein the source beam and the deflected diffraction beam are collinear or substantially collinear.

Aspects of the present disclosure may include methods and systems for providing an acousto-optic deflector (AOD), emitting, toward a deflector plate, a source beam, deflect the source beam, via the deflector plate, to generate a deflected source beam toward the AOD, and diffract, via the AOD, the deflected source beam to generate at least one diffracted beam, wherein source beam and the at least one diffracted beam are substantially collinear.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates an example of a conventional acousto-optic deflector (AOD) according to aspects of the present disclosure.

FIG. 5 illustrates an example of an AOD system that compensates for angle shifts according to aspects of the present disclosure.

FIG. 6 illustrates a first example of an AOD system that compensates for displacement and angle shifts according to aspects of the present disclosure.

FIG. 7 illustrates a second example of an AOD system that compensates for displacement and angle shifts according to aspects of the present disclosure.

FIG. 8 illustrates an example of a method for compensating for angle shifts according to aspects of the present disclosure.

FIG. 9 illustrates an example of a method for compensating for displacement and angle shifts according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

Aspects of the present disclosure include converting off-the-shelf AO devices to a configuration where either the angle shift caused by the diffraction (e.g., via the grating) is fully compensated (i.e., single plate compensation for parallel beams) or both the angle shift and resulting beam displacement are fully compensated (i.e., dual plate compensation for collinear beams).

Certain aspects of the present disclosure may include adding mechanical degrees-of-freedom (e.g., manual or motorized tilt stages) to the external angle control prisms to allow for fine-tuning of the combined assembly to produce collinear incoming and 1st order diffracted beams over a range of wavelengths and acoustic wave frequencies. If the prism tilt angle is identical in both prisms (additional to just optimizing the output angle) the incident angle on the AO device may be optimized to approximately meet the Bragg condition.

An advantage associated with the compensation scheme is that the Bragg angle alignment (typically very sensitive to angle between AO device and the incoming beam) may become much less sensitive with the externally adjusted plates. For example, a 29.9° tilt of an external plated plate may translate to 0.58° beam angle change, which is a 82-fold reduction. This also applies to a single deflector scheme or a dual deflector scheme as described below. A cause for the decreased sensitivity is associated with a result of refraction (i.e., Snell's law) on both surfaces of a tilted plated plate.

As indicated above, QIP systems may rely on light sources to control and/or later the states of the quantum gates used for logic operations. Acousto-optic modulators (AOM) may be used for gate control via amplitude, phase, and frequency modulation of laser beams. Acousto-optic deflectors (AOD) can be used for beam steering, as well as amplitude and phase modulation. However, light beams emitted from the AOM and/or the AOD may impinge on the qubits (atoms, ions, molecules) quantum gates at an angle that degrades the performance and/or fidelity of the QIP system. Aspects of the present disclosure include using one or more deflectors, before or after the AO systems, to control the angle of the light beams. For example, deflectors may be used to cancel or mitigate any unwanted deflection of the light beams going through the AO systems.

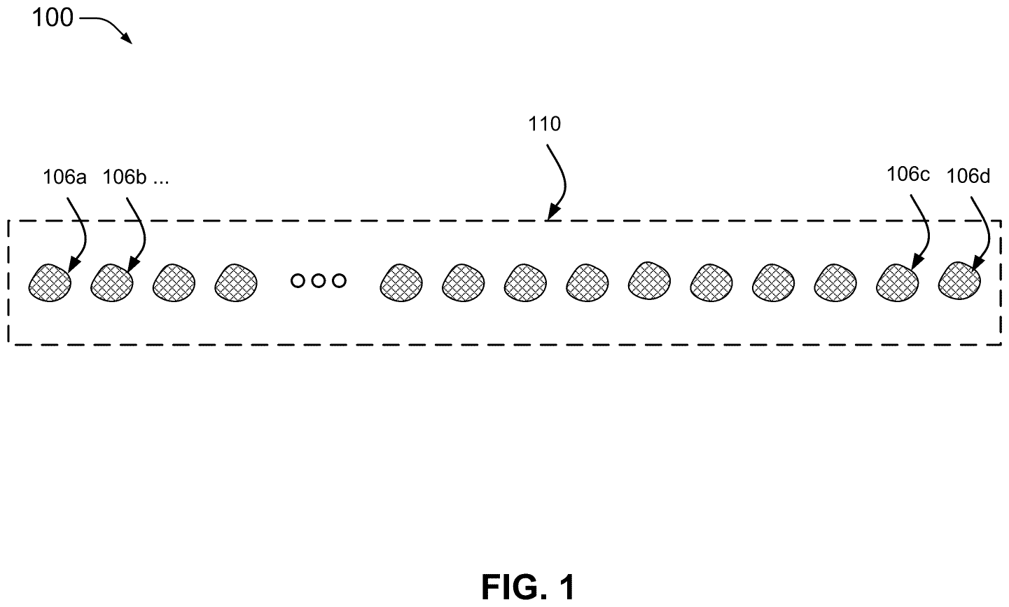

Example QIP systems that may implement aspects of the present disclosure are shown in FIGS. 1-3.

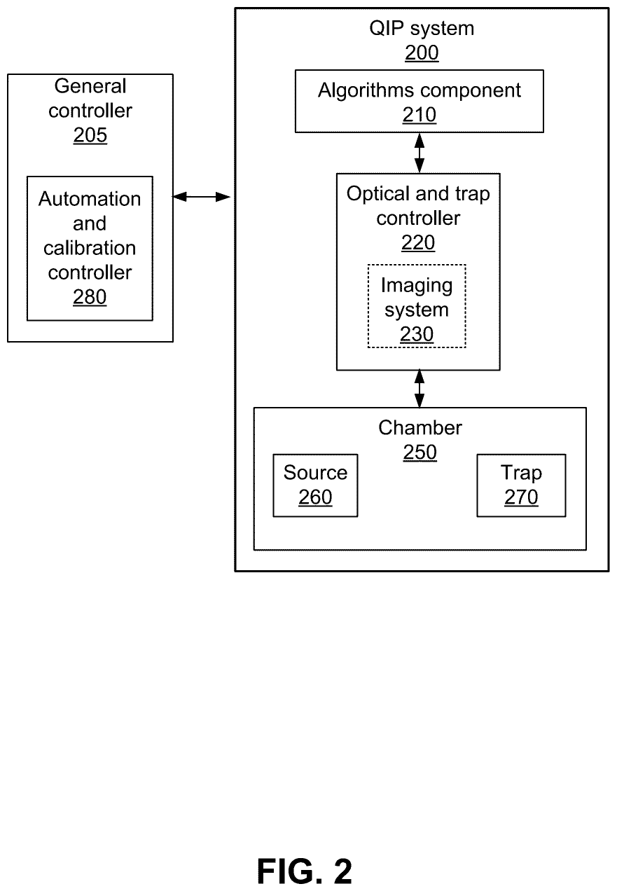

FIG. 1 shown below illustrates a diagram 100 with multiple atomic ions 106 (e.g., atomic ions 106a, 106b, . . . , 106c, and 106d) trapped in a linear crystal or chain 110 using a trap (the trap can be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110.

In the example shown in FIG. 1, the trap includes electrodes for trapping or confining multiple atomic ions into the chain 110 that are laser-cooled to be nearly at rest. The number of atomic ions (N) trapped can be configurable and more or fewer atomic ions may be trapped. The atomic ions can be Ytterbium ions (e.g., 171Yb+ ions), for example. The atomic ions are illuminated with laser (optical) radiation tuned to a resonance in 171Yb+ and the fluorescence of the atomic ions is imaged onto a camera or some other type of detection device. In this example, atomic ions may be separated by about 5 microns (μm) from each other, although the separation may be smaller or larger than 5 μm. The separation of the atomic ions is determined by a balance between the external confinement force and Coulomb repulsion and does not need to be uniform. Moreover, in addition to atomic Ytterbium ions, neutral atoms, Rydberg atoms, different atomic ions or different species of atomic ions may also be used (such as one or more isotopes of barium, for example). The trap may be a linear RF Paul trap, but other types of confinement may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 shown below is a block diagram that illustrates an example of a QIP system 200 in accordance with various aspects of this disclosure.

The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations.

Shown in FIG. 2 is a general controller 205 configured to perform various control operations of the QIP system 200. Instructions for the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. As such, the algorithms component 210 may provide instructions to various components of the QIP system 200 (e.g., to the optical and trap controller 220) to enable the implementation of the quantum algorithms or quantum operations. The algorithms component 210 may receive information resulting from the implementation of the quantum algorithms or quantum operations and may process the information and/or transfer the information to another component of the QIP system 200 or to another device for further processing.

The QIP system 200 may include an optical and trap controller 220 that controls various aspects of a trap 270 in a chamber 250, including the generation of signals to control the trap 270, and controls the operation of lasers and optical systems that provide optical beams that interact with the atoms or ions in the trap. When used to confine or trap ions, the trap 270 may be referred to as an ion trap. The trap 270, however, may also be used to trap neutral atoms, Rydberg atoms, different atomic ions or different species of atomic ions. The lasers and optical systems can be at least partially located in the optical and trap controller 220 and/or in the chamber 250. For example, optical systems within the chamber 250 may refer to optical components or optical assemblies.

The QIP system 200 may include an imaging system 230. The imaging system 230 may include a high-resolution imager (e.g., CCD camera) or other type of detection device (e.g., photomultiplier tube or PMT) for monitoring the atomic ions while they are being provided to the trap 270 and/or after they have been provided to the trap 270. In an aspect, the imaging system 230 can be implemented separate from the optical and trap controller 220, however, the use of fluorescence to detect, identify, and label atomic ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of a processor or processing portion of the QIP system 200. That is, the trap 270 may be considered at the core of the processing operations of the QIP system 200 since it holds the atomic-based qubits that are used to perform the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the general controller 205, the automation and calibration controller 280, the optical and trap controller 220, and/or the imaging system 230.

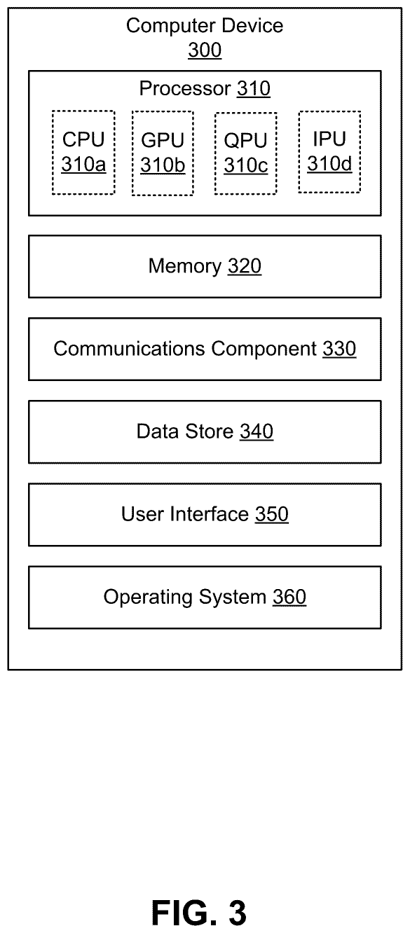

Referring now to FIG. 3 shown below, illustrated is an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single or multiple set of processors or multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

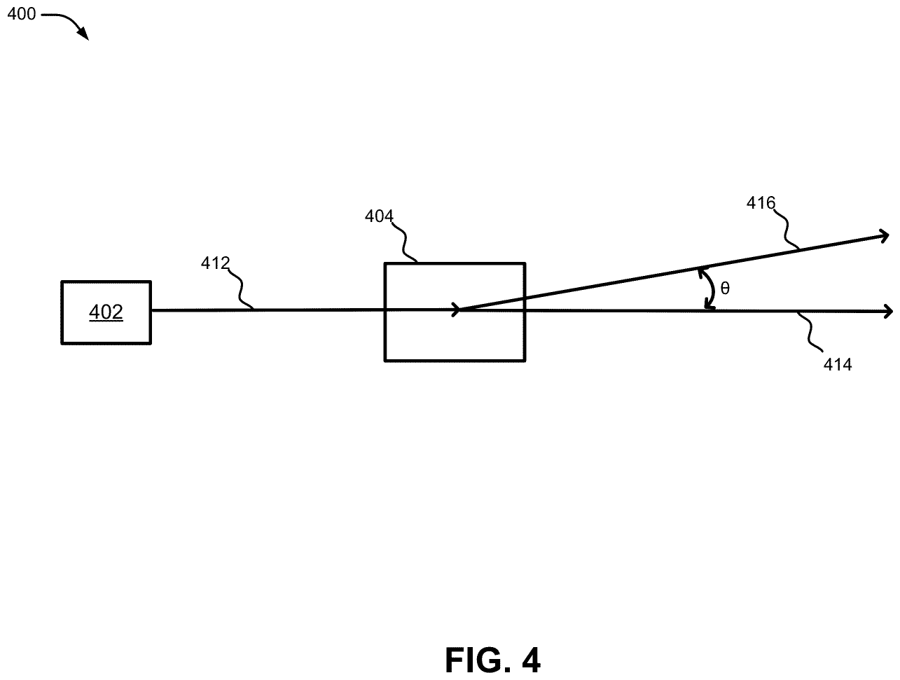

FIG. 4 illustrates a conventional AOD system 400. The AOD system 400 includes a light source 402 configured to produce a source beam 412. The AOD system 400 may include an AOD 404 configured to diffract at least a portion of the source beam 412 to output a remaining source beam 414 and at least one diffracted beam 416. The remaining source beam 414 and the at least one diffracted beam 416 may be emitted from the AOD 404 with an angle difference of an angle θ. The angle θ shown here may be 0.01°, 0.10, 1°, 10°, or other degrees. The range of the angle θ may span a range of 0.001° to 90°. In some aspects, the AOD 404 may include a transducer (not shown) configured to apply one or more acoustic waves to diffract the source beam 412.

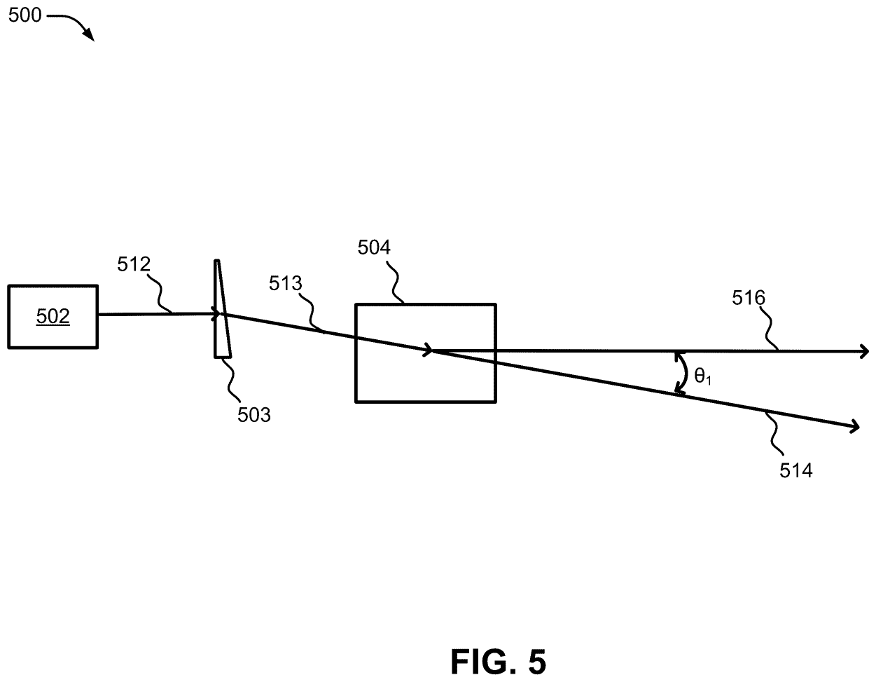

FIG. 5 illustrates a first example of a compensation system according to some aspects of the present disclosure. A compensation system 500 may be implemented to as a part of the optical and trap controller 220 and or the chamber 250. Specifically, the light source used in the optical and trap controller 220 may include the compensation system 500 to control and/or adjust the light used to control the states of the ions in the trap 270.

In some aspects, the compensation system 500 may include the light source 502 configured to emit the source beam 512. The compensation system 500 may include a deflector plate 503 configured to deflect the source beam 512 as a deflected source beam 513. The compensation system 500 may include the AOD 504 configured to diffract at least a portion of the deflected source beam 513 to output the remaining source beam 514 and the at least one diffracted beam 516. The remaining source beam 514 and the at least one diffracted beam 516 may be emitted from the AOD 504 with an angle difference of an angle θ₁. The AOD 504 may include a transducer (not shown) configured to apply one or more acoustic waves to diffract the deflected source beam 513.

During operation, the light source 502 may emit the source beam 512 toward the deflector plate 503. The deflector plate 503 may deflect the source beam 512 by an angle of θ₁ to produce the deflected source beam 513. In other words, the angle difference between the source beam 512 and the deflected source beam 513 may be θ₁. The deflected source beam 513 may be emitted toward the AOD 504. The AOD 504 may apply an acoustic wave to diffract at least a portion of the deflected source beam 513 to produce the remaining source beam 514 and the at least one diffracted beam 516. The remaining source beam 514 and the at least one diffracted beam 516 may be emitted from the AOD 504 with an angle difference of the angle θ₁.

In some aspects, the deflector plate 503 may deflect the source beam 512 by an angle that is identical, but in the opposite direction, as the angle θ₁ caused by the AOD 504 diffracting the deflected source beam 513 to produce the at least one diffracted beam 516. Specifically, the deflector plate 503 may deflect the source beam 512 by the angle of θ₁ in a first direction to produce the deflected source beam 513. As a result, the deflected source beam 513 may approach the AOD 504 at the angle of θ₁ with respect to the source beam 512. The AOD 504 may diffract the deflected source beam 513 at the angle of θ₁ in a second direction, opposite of the first direction, to produce the at least one diffracted beam 516. As such, the deflection by the deflector plate 503 may compensate for the diffraction by the AOD 504 so that the source beam 512 and the at least one diffracted beam 516 are collinear or substantially collinear. In other words, a first line defining the source beam 512 and a second line defining the at least one diffracted beam 516 are substantially parallel, but not overlapping. In some aspects, using a single deflector plate, such the deflector plate 503, may compensate for the angle shift caused by the AOD 504.

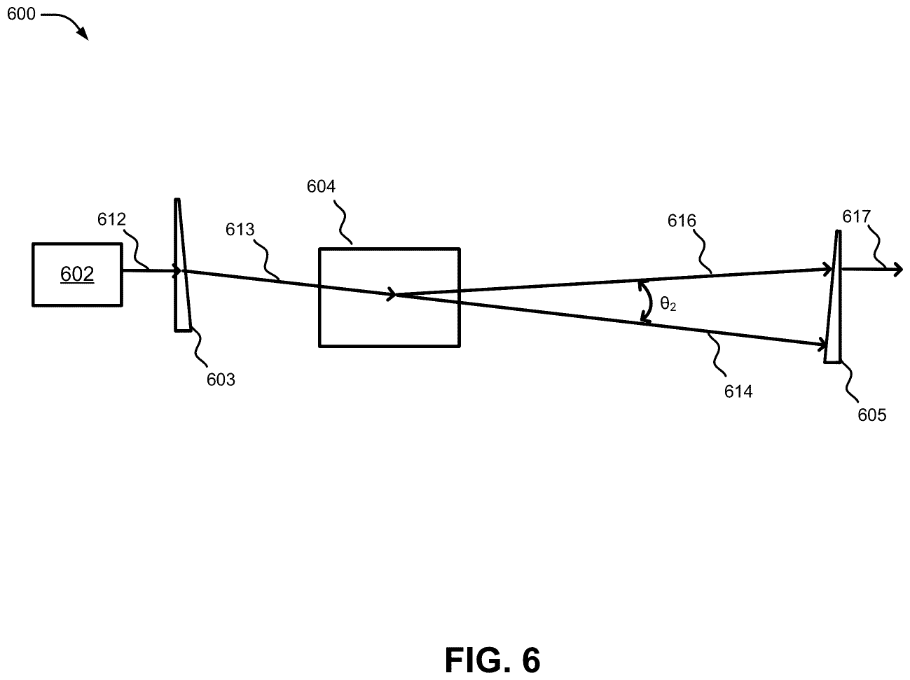

FIG. 6 illustrates a second example of a compensation system according to some aspects of the present disclosure. A compensation system 600 may be implemented to as a part of the optical and trap controller 220 and or the chamber 250. Specifically, the light source used in the optical and trap controller 220 may include the compensation system 600 to control and/or adjust the light used to control the states of the ions in the trap 270.

In some aspects, the compensation system 600 may include the light source 602 configured to emit the source beam 612. The compensation system 600 may include a first deflector plate 603 configured to deflect the source beam 612 as a deflected source beam 613. The compensation system 600 may include the AOD 604 configured to diffract at least a portion of the deflected source beam 613 to output the remaining source beam 614 and the at least one diffracted beam 616. The remaining source beam 614 and the at least one diffracted beam 616 may be emitted from the AOD 604 with an angle difference of an angle θ₂. The AOD 604 may include a transducer (not shown) configured to apply one or more acoustic waves to diffract the deflected source beam 613. The compensation system 600 may include a second deflector plate 605 configured to deflect the at least one diffracted beam 616 as a deflected diffraction beam 617.

During operation, the light source 602 may emit the source beam 612 toward the first deflector plate 603. The first deflector plate 603 may deflect the source beam 612 to produce the deflected source beam 613. The deflected source beam 613 may be emitted toward the AOD 604. The AOD 604 may apply an acoustic wave to diffract at least a portion of the deflected source beam 613 to produce the remaining source beam 614 and the at least one diffracted beam 616. The remaining source beam 614 and the at least one diffracted beam 616 may be emitted from the AOD 604 with an angle difference of the angle θ₂. The at least one diffracted beam 616 may be emitted toward the second deflector plate 605. The second deflector plate 605 may deflect the at least one diffracted beam 616 to generate the deflected diffraction beam 617.

In one aspect of the present disclosure, the deflection by the first deflector plate 603 may deflect the source beam 612 such that the AOD 604 diffracts the at least one diffracted beam 616 into the deflected diffraction beam 617 to be at substantially the same spatial position as the source beam 612. Specifically, the deflection by the first deflector plate 603 may cause the deflected diffraction beam 617 to intersect the line (imaginary) extended from the source beam 612.

In some aspects of the present disclosure, the deflection by the second deflector plate 605 may deflect the at least one diffracted beam 616 such that the deflected diffraction beam 617 is collinear, or substantially collinear, with respect to the source beam 612. In other words, a first line defining the source beam 612 and a second line defining the deflected diffraction beam 617 overlap or substantially overlap.

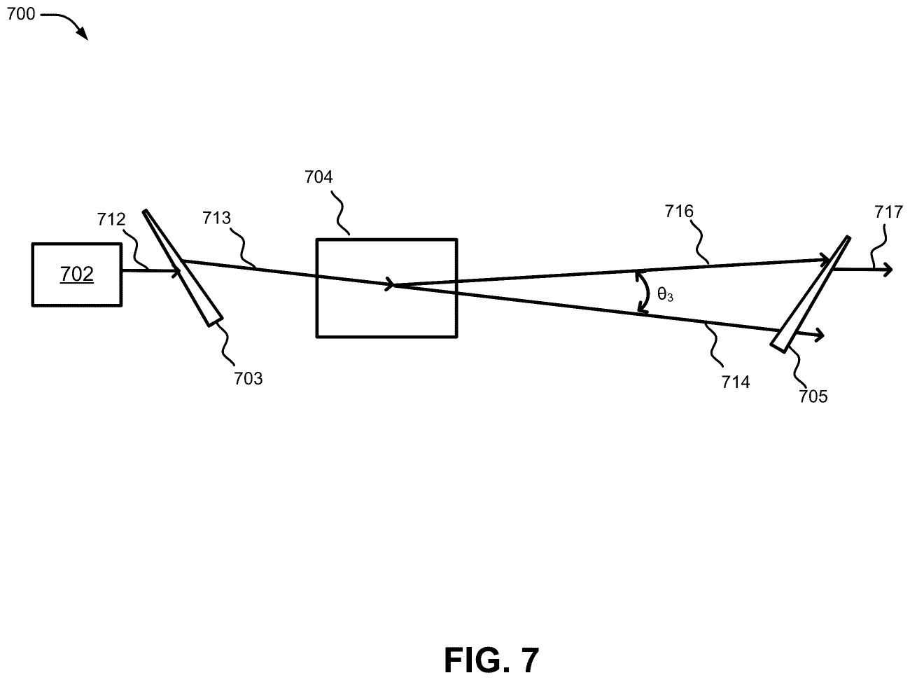

FIG. 7 illustrates a third example of a compensation system according to some aspects of the present disclosure. A compensation system 700 may be implemented to as a part of the optical and trap controller 220 and or the chamber 250. Specifically, the light source used in the optical and trap controller 220 may include the compensation system 700 to control and/or adjust the light used to control the states of the ions in the trap 270.

In some aspects, the compensation system 700 may include the light source 702 configured to emit the source beam 712. The compensation system 700 may include a first deflector plate 703 configured to deflect the source beam 712 as a deflected source beam 713. The first deflector plate 703 may be tilted a first tilt angle. The compensation system 700 may include the AOD 704 configured to diffract at least a portion of the deflected source beam 713 to output the remaining source beam 714 and the at least one diffracted beam 716. The remaining source beam 714 and the at least one diffracted beam 716 may be emitted from the AOD 704 with an angle difference of an angle θ₃. The AOD 704 may include a transducer (not shown) configured to apply one or more acoustic waves to diffract the deflected source beam 713. The compensation system 700 may include a second deflector plate 705 configured to deflect the at least one diffracted beam 716 as a deflected diffraction beam 717. The second deflector plate 705 may be tilted at a second tilt angle.

During operation, the light source 702 may emit the source beam 712 toward the first deflector plate 703. The first deflector plate 703 may deflect the source beam 712 to produce the deflected source beam 713. The first deflector plate 703 may spatially shift the deflected source beam 713 with respect to the source beam 712 and/or deflect the deflected source beam 713 at an angle with respect to the source beam 712. The deflected source beam 713 may be emitted toward the AOD 704. The AOD 704 may apply an acoustic wave to diffract at least a portion of the deflected source beam 713 to produce the remaining source beam 714 and the at least one diffracted beam 716. The remaining source beam 714 and the at least one diffracted beam 716 may be emitted from the AOD 704 with an angle difference of the angle θ₃. The at least one diffracted beam 716 may be emitted toward the second deflector plate 705. The second deflector plate 705 may deflect the at least one diffracted beam 716 to generate the deflected diffraction beam 717. The second deflector plate 705 may spatially shift the deflected diffraction beam 717 and/or deflect the deflected diffraction beam 717 at an angle with respect to the at least one diffracted beam 716.

In one aspect of the present disclosure, the deflections by the first deflector plate 703 and the second deflector plate 705 may deflect the deflected diffraction beam 717 such that the deflected diffraction beam 717 is collinear, or substantially collinear, respect to the source beam 712. In other words, a first line defining the source beam 712 and a second line defining the deflected diffraction beam 717 overlap or substantially overlap.

Various optimizations across the 80 MHz bandwidth of a 532 nm, 100 MHz, TeO2 AOD may be implemented according to aspects of the present disclosure. In a first example, a dual plate configuration of 532 nm, TeO2, 75 MHz, 3.75° plate, and 0.0° tilt may be implemented. In a second example, a dual plate configuration of 532 nm, TeO2, 100 MHz, 3.75° plate, and 29.9° tilt may be implemented. In a third example, a dual plate configuration of 532 nm, TeO2, 125 MHz, 3.75° plate, and 39.8° tilt may be implemented. Other optimization configurations may also be implemented according to aspects of the present disclosure.

In some aspects of the present disclosure, the deflector plates may have an isosceles trapezoidal shape, an acute trapezoidal shape, a right trapezoidal shape, or an obtuse trapezoidal shape. In one aspect, for a right trapezoidal shape deflector plate, the angle of the plate may be 0-10°. In other aspects, the angles of the deflector plate may be different to achieve the desired deflection angle according to aspects of the present disclosure.

In other aspects, the tilting angle of the deflector plates may range from 0-90°. For example, 0°, 60°, 70°, or other degrees of tilt.

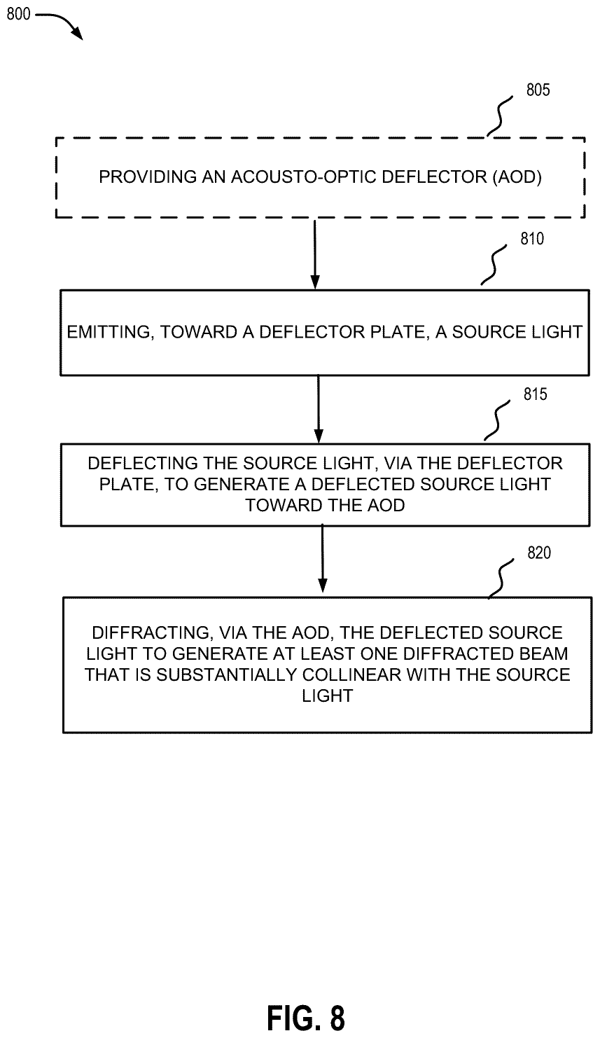

FIG. 8 illustrates an example of a method 800 of angle compensation according to aspects of the present disclosure. In general, it is noted that the method 800 may be performed by the compensation system 500, the compensation system 600, the compensation system 700, and/or one or more components of the compensation system 500, the compensation system 600, or the compensation system 700 according to various exemplary aspects as described above.

Initially, at 805, the method 800 may optionally provide an acousto-optic deflector (AOD). For example, the compensation system 500, the compensation system 600, or the compensation system 700 may be configured to, and/or provide means for providing an acousto-optic deflector (AOD).

At 810, the method 800 may emit, toward a deflector plate, a source light. For example, the light source 502 may be configured to, and/or provide means for emitting, toward a deflector plate, a source light.

At 815, the method 800 may deflect the source light, via the deflector plate, to generate a deflected source light toward the AOD. For example, the deflector plate 503 may be configured to, and/or provide means for deflecting the source light to generate a deflected source light toward the AOD.

At 820, the method 800 may diffract, via the AOD, the deflected source light to generate at least one diffracted beam that is substantially collinear with the source light. For example, the AOD 504 may be configured to, and/or provide means for diffracting the deflected source light to generate at least one diffracted beam that is substantially collinear with the source light.

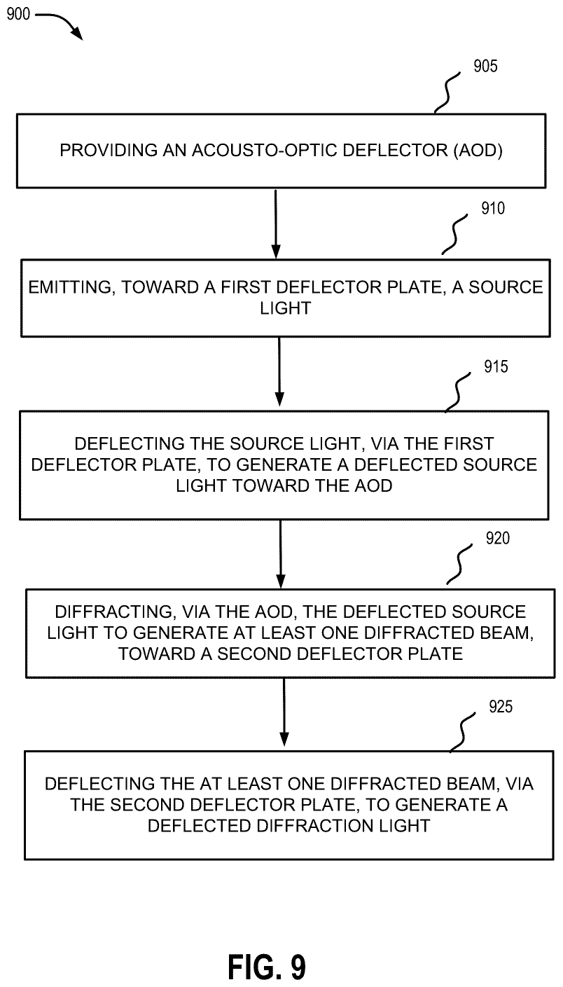

FIG. 9 illustrates an example of a method 900 of displacement and angle compensation according to aspects of the present disclosure. In general, it is noted that the method 900 may be performed by the compensation system 500, the compensation system 600, the compensation system 700, and/or one or more components of the compensation system 500, the compensation system 600, or the compensation system 700 according to various exemplary aspects as described above.

Initially, at 905, the method 900 may provide an acousto-optic deflector (AOD). For example, the compensation system 500, the compensation system 600, or the compensation system 700 may be configured to, and/or provide means for providing an acousto-optic deflector (AOD).

At 910, the method 900 may emit, toward a first deflector plate, a source light. For example, the light source 502, 602, 702 may be configured to, and/or provide means for emitting, toward a first deflector plate, a source light.

At 915, the method 900 may deflect the source light, via the first deflector plate, to generate a deflected source light toward the AOD. For example, the deflector plate 503, the first deflector plate 603, and/or first deflector plate 703 may be configured to, and/or provide means for deflecting the source light to generate a deflected source light toward the AOD.

At 920, the method 900 may diffract, via the AOD, the deflected source light to generate at least one diffracted beam, toward a second deflector plate. For example, the AOD 504, 604, 704 may be configured to, and/or provide means for diffracting the deflected source light to generate at least one diffracted beam, toward a second deflector plate.

At 925, the method 900 may deflect the at least one diffracted beam, via the second deflector plate, to generate a deflected diffraction light. For example, the deflector plate 503, the second deflector plate 605, and/or the second deflector plate 705 may be configured to, and/or provide means for deflecting the at least one diffracted beam to generate a deflected diffraction light.

Aspects of the present disclosure may include methods and systems for providing an acousto-optic deflector (AOD), emitting, toward a deflector plate, a source beam, deflect the source beam, via the deflector plate, to generate a deflected source beam toward the AOD, and diffract, via the AOD, the deflected source beam to generate at least one diffracted beam, wherein source beam and the at least one diffracted beam are substantially collinear.

Aspects of the present disclosure include the method and/or system above, wherein deflecting the source beam comprises generating the deflected source beam at a first angle and diffracting the deflected source beam comprises generating the at least one diffracted beam at a second angle identical to the first angle.

Aspects of the present disclosure include any of the method and/or system above, wherein a first line associated with the source beam and a second line associated with the at least one diffracted beam are parallel and non-overlapping.

Aspects of the present disclosure may include a method and/or a system for providing an acousto-optic deflector (AOD), emitting, toward a first deflector plate, a source beam, deflect the source beam, via the first deflector plate, to generate a deflected source beam toward the AOD, diffract, via the AOD, the deflected source beam to generate at least one diffracted beam, toward a second deflector plate, and deflect the at least one diffracted beam, via the second deflector plate, to generate a deflected diffraction light, wherein the source beam and the deflected diffraction light are collinear or substantially collinear.

Aspects of the present disclosure include the method and/or system above, wherein a first line associated with the source beam and a second line associated with the deflected diffraction light are overlapping.

Aspects of the present disclosure include any of the method and/or system above, wherein deflecting the source beam comprises tilting the first deflector plate.

Aspects of the present disclosure include any of the method and/or system above, wherein tilting the first deflector comprises tilting the first deflector plate by an angle between −90° and 90°.

Aspects of the present disclosure include any of the method and/or system above, where deflecting the at least one diffracted beam comprises tilting the second deflector plate.

Aspects of the present disclosure include any of the method and/or system above, wherein tilting the second deflector comprises tilting the second deflector plate by an angle between −90° and 90°.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of angle and displacement compensation, comprising:
emitting, toward a deflector plate, a source beam;
deflecting the source beam, via the deflector plate, to generate a deflected source beam toward an acousto-optic deflector (AOD); and
diffracting, via the AOD, the deflected source beam to generate at least one diffracted beam that is substantially collinear with the source beam.

2. The method of claim 1, wherein:
deflecting the source beam comprises generating the deflected source beam at a first angle; and
diffracting the deflected source beam comprises generating the at least one diffracted beam at a second angle identical to the first angle.

3. The method of claim 1, wherein a first line associated with the source beam and a second line associated with the at least one diffracted beam are parallel and non-overlapping.

4. An acousto-optic deflector (AOD) system, comprising:
a light source configured to provide a source beam toward a deflector plate;
the deflector plate configured to deflect the source beam to generate a deflected source beam toward an AOD; and
the AOD configured to diffract the deflected source beam to generate at least one diffracted beam, wherein source beam and the at least one diffracted beam are substantially collinear.

5. The AOD system of claim 4, wherein:
the deflector plate is further configured to generate the deflected source beam at a first angle; and
the AOD is further configured to generate the at least one diffracted beam at a second angle identical to the first angle.

6. The AOD system of claim 4, wherein a first line associated with the source beam and a second line associated with the at least one diffracted beam are parallel and non-overlapping.

7. A method of angle and displacement compensation, comprising:
providing an acousto-optic deflector (AOD);
emitting, toward a first deflector plate, a source beam;
deflecting the source beam, via the first deflector plate, to generate a deflected source beam toward the AOD;
diffracting, via the AOD, the deflected source beam to generate at least one diffracted beam, toward a second deflector plate; and
deflecting the at least one diffracted beam, via the second deflector plate, to generate a deflected diffraction light that is substantially collinear with the source beam.

8. The method of claim 7, wherein a first line associated with the source beam and a second line associated with the deflected diffraction light are overlapping.

9. The method of claim 7, wherein deflecting the source beam comprises tilting the first deflector plate.

10. The method of claim 9, wherein tilting the first deflector comprises tilting the first deflector plate by an angle between −90° and 90°.

11. The method of claim 7, where deflecting the at least one diffracted beam comprises tilting the second deflector plate.

12. The method of claim 11, wherein tilting the second deflector comprises tilting the second deflector plate by an angle between −90° and 90°.

13. An acousto-optic deflector (AOD) system, comprising:
a light source configured to emit, toward a first deflector plate, a source beam;
the first deflector plate configured to deflect the source beam to generate a deflected source beam toward an AOD;
the AOD configured to diffract the deflected source beam to generate at least one diffracted beam toward a second deflector plate; and
the second deflector plate configured to deflect the at least one diffracted beam to generate a deflected diffraction light that is substantially collinear with the source beam.

14. The AOD system of claim 13, wherein a first line associated with the source beam and a second line associated with the deflected diffraction light are overlapping.

15. The AOD system of claim 13, wherein the first deflector plate is further configured to tilt.

16. The AOD system of claim 15, wherein the first deflector plate is further configured to tilt between −90° and 90°.

17. The AOD system of claim 13, wherein the second deflector plate is further configured to tilt.

18. The AOD system of claim 17, wherein the second deflector plate is further configured to tilt between −90° and 90°.
